(19) United States
(12) Patent Application Publication
(10) Pub. No.: US 2013/0036616 A1
(43) Pub. Date: Feb. 14, 2013

(54) Dual point hobby knife blade

(71) Applicant: Terry Lee Wagenknecht, Rockford, IL (US)

(72) Inventor: Terry Lee Wagenknecht, Rockford, IL (US)

(21) Appl. No.: 13/136,813

(22) Filed: Aug. 11, 2011

(51) Int. Cl. B26B 9/02

(52) U.S. Cl. 30/351

(57) ABSTRACT

The apex portion of a triangular shape hobby knife blade has a linear cutting edge margin angling inward toward the apex, and an opposing lineal blunt edge margin having a single blunt edge notch to form both a blunt edge corner point within the blunt edge, and a cutting edge point tip at a distal end of the cutting edge. A concave portion of the notch is intermediate a beginning and ending portion; and with the notch as defined by the ending portion being directionally oriented to the elongate edges between a first angle and a second angle. The corner point and notch impede a penetration of the blade after the distal cutting tip impresses or pierces the skin; and also enables a motion toward the apex by the user to maneuver cut away substrate pieces without piercing damage. Shifting the blade toward the die cut or grinding forming means creates a larger notch to establish a new sharp distal cutting edge point tip within a previously damaged blade to serve as a cheaper alternative to the segmented break away blades.

### CROSS-REFERENCE TO RELATED APPLICATIONS

None

### STATEMENT REGARDING FEDERALLY SPONSORED RESEARCH OR DEVELOPMENT

Not applicable.

### REFERENCE TO SEQUENCE LISTING

Not applicable.

### BACKGROUND

1. Field of Invention

The present invention relates to the edge structure of the apex portion of a flat and elongate triangular shape metal hobby knife blade or surgeons scalpel.

2. Description of Prior Art

Generally flat, and elongate triangular shape single cutting edge metal hobby knife blades for fine detailed hand cutting have an elongate linear cutting edge and an opposing elongate linear blunt edge extending from the blades shank area to the apex tip portion with either edge being less than 3 inches in length.

The cutting edge is normally angular to the elongate direction of the blades main body and shank. The opposing blunt edge is either parallel or angular to the elongate direction of the blade's main body and shank.

The long narrow triangular shape blade tapers into such an extremely sharp point that its benefits of being near to a surgeons scalpel also have several drawbacks including the ability of the blade to instantly pierce a users flesh up to the full depth of the blades main body, or the inability of the blade to maneuver a wanted cut away portion of a substrate without piercing or damaging the wanted portion.

A clear drawback is the premature chipping and so dulling of the hardened metal blade which has an extremely tapered and finely ground cutting edge point tip; and with limited options of replacing the tip by standard time consuming sharpening methods or honing.

Not included in todays tip replacement is an alternative to the more expensive trapezoidal shape segmental break away blade to establish a new cutting edge tip. After chipping the tip, It is convenient but expensive for the hobbyist to just reach for a new same blade each time for a sharp new cutting edge point tip replacement.

It is well known that humans have more nerve endings in their hands and finger tips than anywhere else in the body, and where more injuries still occur to the hands than any other body part while manipulating a hobby knife.

An autonomic response of flinching away from the source of harm is determined between the lowest portion of the users brain and the upper portion of the spinal column; or the brainstem.

Only a very small group of nerve endings, or in at least only one nerve ending signal is enough to trigger an autonomic response of a flinching away from the source of harm; and within a physical space of less than a pinpoint of a needle; and within only a very short amount of time while requiring no contemplation by the user.

Prior triangular shape hobby knife blades have only one piercing end point tip to alert the user upon any piercing of the blade into their body. Prior art does not include any blades with two laterally spaced apart piercing point locations or longitudinally and so time spaced piercing point locations to give a user multiple skin surface nerve stimuli locations of edge point piercing to more assuredly respond within the autonomic flinching away from a skin impressing or piercing blade tip.

Prior triangular shape hobby knife blades having one elongate linear cutting edge margin and one elongate linear blunt edge margin do not have an added blunt edged corner point or blunt edged notch within the elongate blunt edge of the blade to additionally at least physically impede a full penetration of the blade into the skin or hands of the user after any first impressing or piercing of the most distal end point cutting edge tip.

While using prior art of triangular shape hobby knife blades, the hobbyist is not able to maneuver the blade in a direction toward the blades apex point tip without the blades extremely sharp apex point tip causing a damage or piercing to the portion needing to be cut away, maneuvered or held. Previous triangular shape blades lack either the blunt edge corner point or blunt edge notch to accomplish a towards the apex direction of maneuvering the blade in a non destructive manner.

Most prior art triangular shape single cutting edge hobby knife blades have a primary bevel and secondary bevel on each planar side of the blade, and with both sharpened sides and the opposing blunt edge tapering inward toward the apex point to establish the described most vulnerable part; and which is the distal cutting edge point tip being most easily or almost always immediately dulled or chipped off upon its first use or contact against any hard surface.

Prior art of triangular shape hobby knife blades which may be newly sharpened at the distal cutting edge point tip by the user with standard hand sharpening means or honing means is difficult and time consuming due to the blades almost infinite tapering at the blades apex point tip.

### SUMMARY

A dual point elongate triangular shape hobby knife blade comprises a blade end apex area having a defined single blunt edge concave arcuate notch within a linear blunt edge to create both a blunt edge corner point within the blunt edge and a sharp cutting edge point tip at a distal end of the blade's linear cutting edge.

The two resulting points are laterally and longitudinally spaced to provide two locations of nerve signal stimuli for a more assured and so faster autonomic response to at least impede any further penetration of the blade after the sharp distal cutting edge point tip has impressed or pierced the skin of a hobby knife user.

While both the blunt edged concave arcuate portion of the notch and the corner point serve to impede a blades penetration; either one or both the notch and corner point additionally enable a forward pushing motion toward the apex area by a user to remove or hold or maneuver cut away substrate pieces without damaging or piercing the pieces; and as when compared to using the sharp distal cutting edge point tip while maneuvering the blade in the same direction toward the apex area.

The dual point blade is easily re-sharpened by die punched means, or dry or wet grinding wheel means or by forming a larger notch further inward from the blades apex, or by shifting the blade toward the die or grinding element of the forming means; and where the single notch dual point blade provides an alternative to the more expensive segmented break away blades to establish multiple new sharp distal cutting edge point tips.

Whereas most existing forms of elongate triangular shape hobby knife blades closely resemble a surgeons scalpel; this invention of a dual point safety blade enables the parent of a young child novice hobbyist to have a choice of placing a much safer blade in the childs hands; and may be comparable to using a bicycle's training wheels before learning to safely manipulate a surgeons scalpel like blade.

### Objects and Advantages

A first object of the invention is to provide a safer triangular shape hobby knife blade having two nerve stimuli signaling piercing point locations which replace prior art of a single piercing signaling location, and with the improvement being; a single notch within the elongate linear blunt edge which creates both the corner point within the elongate linear blunt edge and the sharp cutting edge point tip at a distal end of the elongate linear cutting edge to enable several other advantages.

An added advantage or benefit of the first object also includes the two piercing point locations to be distanced longitudinally and laterally from each other for multiple and separately timed nerve signal stimuli to be sent to the brainstem of the user for a better assured autonomic response; and in so, at least an enhanced autonomic response of flinching away by the user between the first skin impressing or skin piercing of the distal sharp cutting edge point tip and the subsequent impressing or piercing of the corner point into the skin.

The first object also includes the advantage or benefit of either one or in combination of; the corner point of the notch or the blunt edge ending portion of the notch or the blunt edge concave arcuate portion of the notch within the elongate blunt edge to physically at least impede any further piercing of the blade after the most distal end point cutting edge tip of the elongate cutting edge has pierced the skin of a user.

A second object of the invention is to enable the user to maneuver the blunt edge corner point, or the ending portion of the notch, or the arcuate portion of the notch of the blade in a direction toward the blades apex area, and with no damage or piercing to the cut away portion needing to be cut away, maneuvered or held.

A third object of the invention is to form a safer blade with dual end point tips from a virgin blank metal substrate, or from a new or used previously formed prior art triangular shape hobby knife blade, or from a previously used dual point safety blade; and where a means for forming the notch may include a dry or wet grinding process using a standard cylindrical grinding wheel, or a convex shape grinding wheel, or a machine stamping or hand die punching process to create the single notch, the corner point, and the new sharp distal cutting edge point tip.

The third object also enables the user to repeatedly re-form the same blade multiple times by simply forming a larger notch further inward from the blades apex area, or by shifting the blade further toward the die cutting means or dry or wet grinding means to create a sharp new cutting edge point tip at the distal end of the elongate linear cutting edge; and which may include a new corner point location within the elongate blunt edge.

The third object also provides an easy alternative to the standard and more expensive trapezoid shape segmented break away blades for establishing multiple new sharp distal end point cutting edge tips. The dry grinding means may produce minute size burrs remaining attached to the newly formed sharp distal end point cutting tip of the elongate cutting edge, but are immediately and abrasively rubbed or burnt away with the first pressured cutting stroke made by the user.

A fourth object of the invention is to more exactly distinguish a notch from an indentation within the elongate blunt edge by defining the elements of the notch as having a beginning portion which creates the sharp distal cutting edge point tip of the elongate cutting edge, an ending portion which creates the corner point tip within the elongate blunt edge, and with the concave arcuate portion being intermediate the beginning and ending portions.

The ending portion of the notch adjacent the corner point is oriented as being between a first angle and a second angle according to the elongate linear edges; and where the first angle is a six degree plus or minus angle of the ending portion being near perpendicular to the elongate direction of the elongate linear blunt edge which is immediately adjacent the corner point; and where the second angle is the ending portion being approximately parallel with the elongate linear cutting edge. The six degree plus or minus angle allows for a margin of error being just under two percent while forming the notch using a hand held clear plastic wet grinding component having a low visibility or cloudy liquid grinding solution; and yet with the finished blade end still retaining all five elements of the defined notch.

The blunt edge corner point, the blunt edge ending portion and its defined angle in relation to the elongate edges, and the blunt edge concave arcuate portion are all cooperative to define the notch as a notch; and not a concave arcuate indention as within a Jim Bowie type of blade to facilitate penetration; but with the defined parts of the notch being cooperatively restrictive to the blade's penetration after the sharp distal end point cutting tip of the elongate cutting edge has first impressed or pierced the skin or hands of the hobby knife user.

Although enclosed descriptions contain many specifics, these should not be understood as limiting the scope of the invention but as merely providing illustrations of the presently preferred embodiments of this invention.

### REFERENCE NUMERALS IN DRAWINGS

10—a blade's shank portion.
20—a blade end areas elongate linear cutting edge within a bordering margin being angular to the main body and shank portion.
22—an angle of the ending portion being parallel with the elongate cutting edge, and also referred to as a second angle.
25—a blade ends apex area.
30—a blade end area's notch created sharp distal cutting point tip at a distal end of the elongate linear cutting edge margin.
40—a blade end area's notched portion within the elongate linear blunt edge.
45—a concave arcuate portion of the notch.
46—a blade end area's circular notch portion within the elongate linear blunt edge.
50—a blunt edged beginning portion of the notch adjacent the sharp distal cutting edge point tip.
55—a blunt edged ending portion of the notch adjacent the blunt edge corner point.
60—a blade end area's notch created blunt edge corner point.
66—a six degrees plus or minus angle of the ending portion being near perpendicular to the elongate direction of the elongate linear blunt edge, and also referred to as a first angle.
70—a blade end areas elongate linear blunt edge within a bordering margin being parallel to the main body and shank portion.
75—a blade end areas elongate linear blunt edge within a bordering margin being angular to the main body and shank portion.
80—a blade's main body portion.
90—a human user's skin surface.
91—a first skin piercing point location.
92—a second skin piercing point location.

### BRIEF DESCRIPTION OF THE DRAWINGS

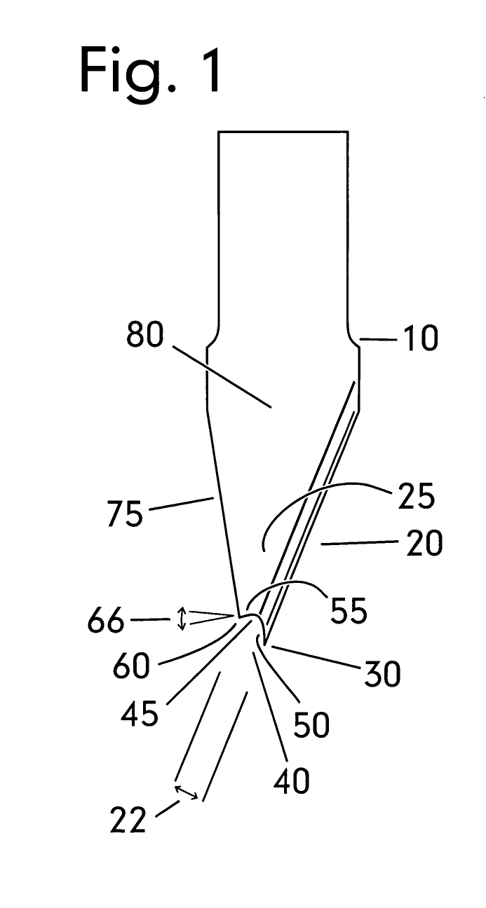

FIG. 1 shows a plan view of the preferred embodiment.

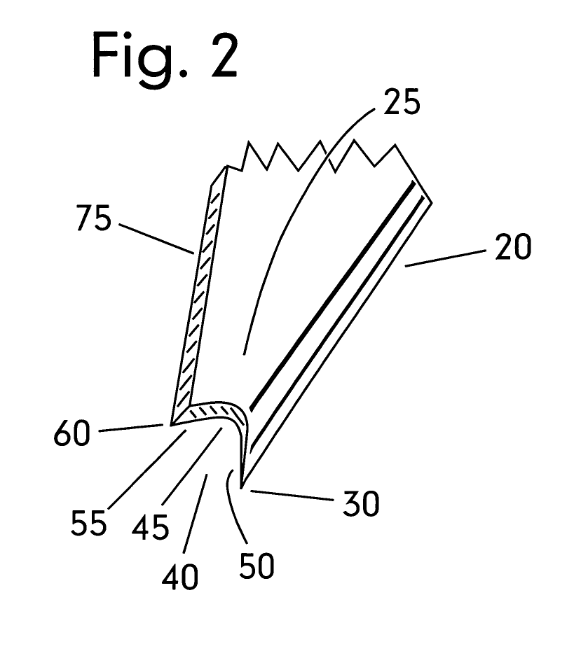

FIG. 2 is a partial and enlarged perspective view of some elements of FIG. 1.

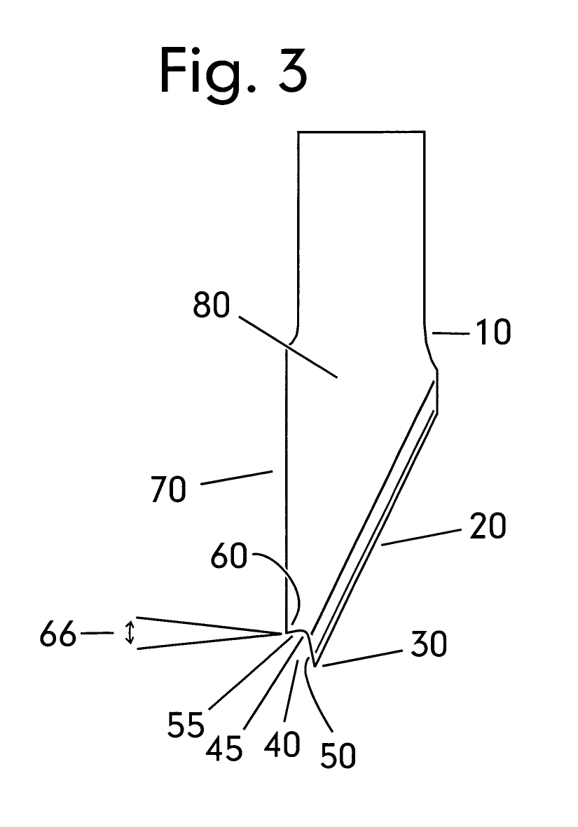

FIG. 3 is a plan view of an alternative embodiment having an elongate lineal blunt edge margin being parallel with the shank and main body.

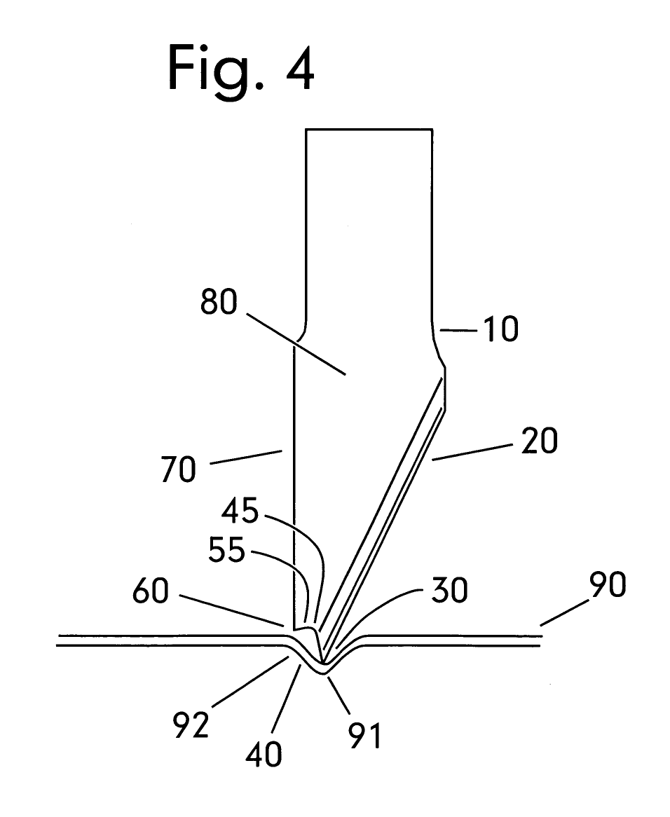

FIG. 4 shows a plan view of the alternative embodiment of FIG. 3 almost piercing a skin surface.

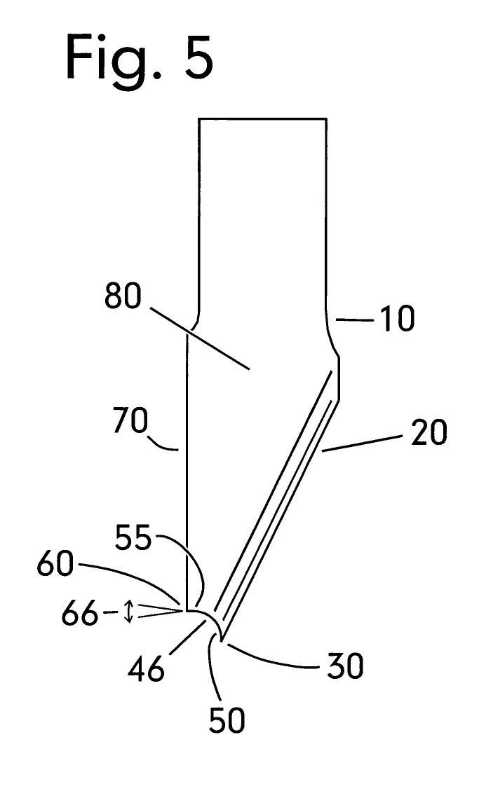

FIG. 5 is a plan view of an alternative embodiment having a circular notch and an elongate lineal blunt edge margin being parallel with the shank and main body.

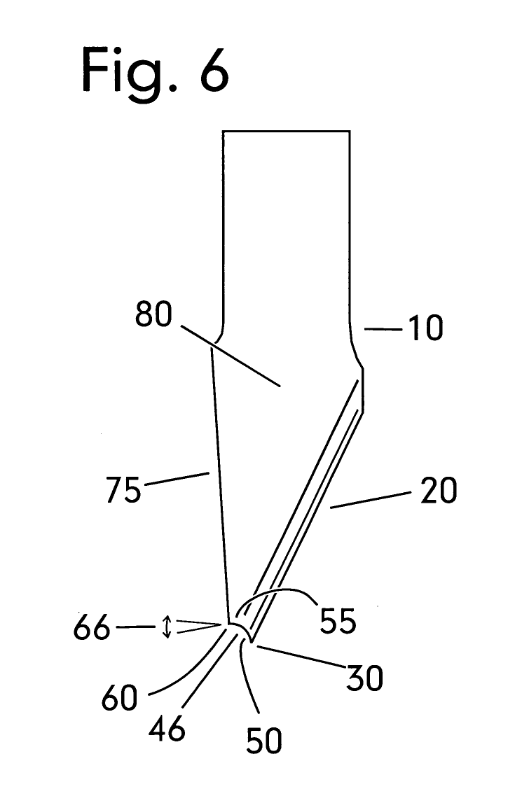

FIG. 6 is a plan view of an alternative embodiment having a circular notch and an elongate lineal blunt edge margin being angular to the shank and main body.

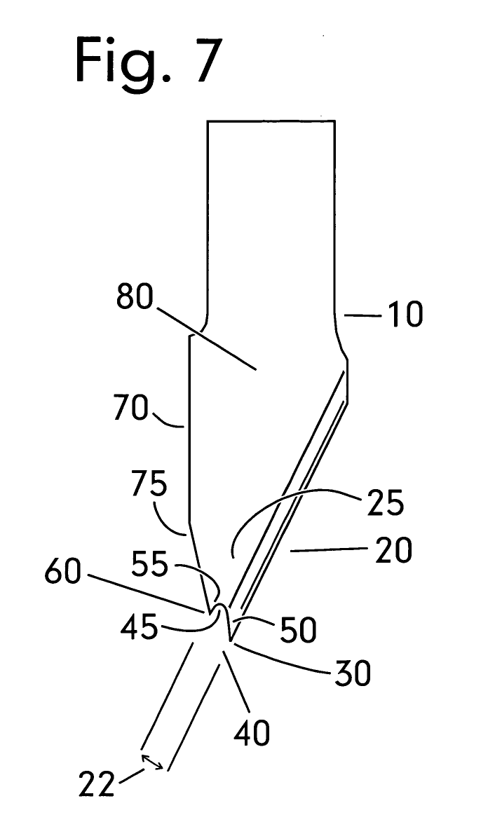

FIG. 7 is a plan view of one embodiment having an angle of the ending portion of the notch being approximately parallel with the elongate cutting edge.

### DETAILED DESCRIPTION OF THE DRAWINGS—PREFERRED EMBODIMENT

The preferred embodiment within the plan view of FIG. 1 includes a notched area (40) within a bordering margin having an elongate linear blunt edge (75); and where the notch creates both the sharp cutting edge point tip (30) at a distal end of a bordering margin having an elongate linear cutting edge (20), and the blunt edge corner point (60) within the elongate linear blunt edge (75), and with both elongate edges (20) (75) being angular in direction to the main body (80) and shank (10). Defining parts of the notch (40) within the blade ends apex area (25) include a concave arcuate portion (45) being intermediate a beginning portion (50) which is adjacent the cutting edge point tip (30) and an ending portion (55) which is adjacent the corner point (60). The angle of the ending portion (55) in relation to the elongate lineal blunt edge (75) is shown as being between a first angle (66) and a second angle (22). The first angle (66) is defined as the ending portion being within plus or minus 6 degrees of the ending portion (55) being perpendicular in direction to the elongate blunt edge (75). The second angle (22) is defined only within FIG. 1 by two parallel lines representing the ending portion (55) being parallel in direction with the elongate cutting edge (20).

### DETAILED DESCRIPTION OF THE DRAWINGS

FIG. 2 is a partial and enlarged perspective view showing some of the elements of FIG. 1 including a notched area (40) forming both the sharp distal cutting point tip (30) within the elongate linear cutting edge (20) and the blunt edge corner point (60) within the elongate linear blunt edge (75). Defining parts of the notch (40) at the distal end of the apex area (25) include a concave arcuate portion (45) being intermediate a beginning portion (50) and an ending portion (55).

FIG. 3 is a plan view of an alternative embodiment having a notch (40) with at least a portion being concave or arcuate (45) and an elongate blunt edge (70) being parallel with the shank (10) and main body (80), and a six degree plus or minus angle and which is also referred to as a first angle (66) of the ending portion (55) being near perpendicular to a portion of the elongate blunt edge (70) which is adjacent the blunt edge corner point (60). A beginning portion (50) of the notch (40) is shown adjacent the sharp distal cutting point tip (30) of the elongate cutting edge (20) which is angular in direction to the shank (10) and main body (80).

FIG. 4 shows a plan view of the alternative embodiment of FIG. 3, and showing a notch (40) with at least a portion being concave or arcuate (45), and an elongate blunt edge (70) being parallel with the shank (10) and main body (80), and an ending portion (55) being near perpendicular to a portion of the elongate blunt edge (70) which is adjacent the blunt edge corner point (60). The sharp distal cutting point tip (30) of the elongate cutting edge (20) which is angular in direction to the shank (10) and main body (80) is shown impressing into and almost piercing a skin surface (90) at a first piercing location (91) and with the corner point (60) being nearly ready to impress and pierce a second piercing location (92). Note how the corner point (60) is spaced laterally outward and longitudinally inward from the sharp distal cutting tip (30) to enable both a dimensional distance spacing and so multiple nerve signal stimuli locations, and also a time distance spacing between both piercing point locations of (91) and (92).

### DETAILED DESCRIPTION OF THE DRAWINGS

FIG. 5 is a plan view of an alternative embodiment having a circular notch (46), and an elongate blunt edge (70) being parallel with the shank (10) and main body (80), and a six degree plus or minus angle and which is also referred to as a first angle (66) of the ending portion (55) being near perpendicular to a portion of the elongate blunt edge (70) which is adjacent the blunt edge corner point (60). A beginning portion (50) of the circular notch (46) creates the sharp distal cutting point tip (30) of the elongate cutting edge (20) which is angular in direction to the main body (80) and shaft (10).

FIG. 6 is a plan view of an alternative embodiment having a circular notch (46), and an elongate blunt edge (75) being angular to the shank (10) and main body (80), and a six degree plus or minus angle and which is also referred to as a first angle (66) of the ending portion (55) being near perpendicular to a portion of the elongate blunt edge (75) which is adjacent the blunt edge corner point (60). A beginning portion (50) of the circular notch (46) creates the sharp distal cutting point tip (30) of the elongate cutting edge (20) which is angular indirection to the main body (80) and shaft (10).

FIG. 7 is a plan view of an alternative embodiment having a notch (40) with at least a portion being concave or arcuate (45), and an elongate blunt edge (70) being parallel with the main body (80) and adjacent to and parallel with the shank (10), and an elongate blunt edge (75) which is angular to the main body (80) and shank (10) and located within the apex area (25). Also shown is a second angle (22) of the ending portion (55) being approximately parallel with the elongate cutting edge (20). A beginning portion (50) of the notch (40) creates the sharp distal cutting point tip (30) of the elongate cutting edge (20) which is angular in direction to the main body (80) and shaft (10), and where the ending portion (55) creates the corner point (60) within the angled elongate blunt edge (75).

### DETAILED DESCRIPTION OF THE DRAWINGS—OPERATION

A new dual point safety blade may be formed by current standard manufacturing processes including progressive machine stamping and grinding. The machine stamping or die cut portion of the notch (40) (46) within the elongate linear blunt edge (70) (75) forms both the corner point (60) and the sharp distal cutting edge point tip (30).

The notch is defined as a notch by the linear direction of angle of the ending portion (55) of the notch (40) being oriented between a first angle (66) and a second angle (22).

The first angle is defined as the ending portion being within plus or minus 6 degrees of the ending portion (55) being perpendicular in direction to the portion of the elongate blunt edge (75) which is immediately adjacent the corner point (60).

The second angle (22) is defined as the ending portion (55) being parallel in direction with the elongate cutting edge (20).

A previously made or dulled or chipped blade may be converted to a dual point safety blade by machine punching or hand die punching a circular shape notch (46) or a notch having a concave arcuate portion (45) of the notch (40) within the elongate blunt edge (70) (75) or by dry or wet grinding the notch (40) (46) with a cylindrical shape or convex shape grinding wheel.

As the outer surface of the cylindrical shape grinding wheel removes metal material from the elongate blunt edge (70) (75), the 90 degree corner edge of the grinding wheel wears away and rounds out to form the concave arcuate portion (45) of the notch (40). New or repeated sharp distal end cutting point replacement tips (30) are formed by shifting the blade further toward the grinding means, and where the arcuate portion of the notch prevents a fracturing of the hardened steel blade.

1. The apex portion of a flat elongate triangular shape metal hobby knife blade end comprises
a bordering margin having an elongate lineal cutting edge extending less than three inches in length,
a bordering margin having an elongate lineal blunt edge extending less than three inches in length,
a single notch within said elongate lineal blunt edge;
wherein said single notch has a blunt edge;
wherein at least a portion of said single notch is arcuately concave;
and wherein said single notch creates a corner point within said linear blunt edge and a sharp cutting edge point tip at a distal end of said linear cutting edge.

2. The apex portion of a flat elongate triangular shape metal hobby knife blade end comprises
a bordering margin having an elongate lineal cutting edge extending less than three inches in length,
a bordering margin having an elongate lineal blunt edge extending less than three inches in length,
a single notch within said elongate lineal blunt edge;
wherein said single notch has a blunt edge;
wherein at least a portion of said single notch is arcuately concave;
wherein said single notch creates a corner point within said linear blunt edge and a sharp cutting edge point tip at a distal end of said linear cutting edge.
and wherein said single notch is displaced by a dimensionally larger said notch to establish a new said distal cutting edge point tip.

3. The apex portion of a flat elongate triangular shape metal hobby knife blade end comprises
a bordering margin having an elongate lineal cutting edge extending less than three inches in length,
a bordering margin having an elongate lineal blunt edge extending less than three inches in length,
a means of forming a single notch located within said elongate linear blunt edge;
wherein said single notch has a blunt edge;
wherein at least a portion of said single notch is arcuately concave;
wherein a sharp distal cutting edge point tip is created by a beginning portion of said single notch at a distal end of said linear cutting edge;
wherein said elongate linear blunt edge has a corner point created by an ending portion of said single notch;
wherein said arcuate portion is approximately intermediate said beginning portion and said ending portion;
wherein said corner point is located laterally outward and longitudinally inward from said distal cutting edge point tip;
wherein a first angle includes said ending portion being approximately perpendicular to said elongate blunt edge within up to plus or minus six degrees;
wherein a second angle includes said ending portion being approximately parallel with said elongate cutting edge;
and wherein said single notch is defined by said ending portion being aligned with said elongate edges as being between said first angle and said second angle.

4. The means of claim 3 wherein said notch is formed by machine stamping.

5. The means of claim 3 wherein said notch is formed by a hand punch die cutter.

6. The means of claim 3 wherein said notch is formed by a cylindrical grinding wheel.

7. The means of claim 3 wherein said notch is formed by a convex grinding wheel.

8. The notch of claim 1 wherein said notch is entirely circular in shape.

9. The notch of claim 2 wherein said notch is entirely circular in shape.

10. The notch of claim 3 wherein said notch is entirely circular in shape.

11. The elongate cutting edge of claim 1 being angular to the elongate length of the blade.

12. The elongate cutting edge of claim 2 being angular to the elongate length of the blade.

13. The elongate cutting edge of claim 3 being angular to the elongate length of the blade.

14. The elongate blunt edge of claim 1 being angular to the elongate length of the blade.

15. The elongate blunt edge of claim 2 being angular to the elongate length of the blade.

16. The elongate blunt edge of claim 3 being angular to the elongate length of the blade.

17. The elongate blunt edge of claim 1 being parallel with the elongate length of the blade.

18. The elongate blunt edge of claim 2 being parallel with the elongate length of the blade.

19. The elongate blunt edge of claim 3 being parallel with the elongate length of the blade.
